(19) United States
(12) Patent Application Publication
(10) Pub. No.: US 2006/0244167 A1
(43) Pub. Date: Nov. 2, 2006

(54) Method and device for control of the thickness of extruded film

(76) Inventors: Bartholomeus Trommelen, Gronau (DE); Lothar Koenig, Westerkappeln (DE)

Correspondence Address: JACOBSON HOLMAN PLLC, 400 SEVENTH STREET N.W., SUITE 600, WASHINGTON, DC, 20004, US

(21) Appl. No.: 10/541,363

(22) PCT Filed: Dec. 9, 2003
(86) PCT No.: PCT/EP03/14037

§ 371 Date: May 1, 2006

(30) Foreign Application Priority Data
Jan. 6, 2003 (DE) 103 00 375.4

(51) Int. Cl. B29C 47/92

(52) U.S. Cl. 264/40.1; 425/141

(57) ABSTRACT

The present invention relates to a process for the automatic control of the thickness of extruded film (8). The purpose of the invention is to lower the deviations in the thickness of the film more quickly after the start of the extrusion process.

The process involves the measurement of the thickness profile of the film just extruded (8) by means of a thickness-measuring probe (12). The thickness-measuring probe (12) is moved along the surface of the film substantially perpendicular (x) to the conveying direction (z) of the extruded film (8). The thickness-measuring probe (12) records for each measuring cycle (MZ) a thickness profile (P) of the film (8) at least over parts of the expansion of the film (8) perpendicular (x) to its conveying direction (z).

The process pursuant to the present invention is characterized by the fact that during a predetermined time-frame at the start of the extrusion process measured values or information derived therefrom using or for a greater number of measuring cycles is made accessible to the computer (14) than those recorded by the thickness-measuring probe (12) in a time-frame of similar length during the normal operation and that the computer (14) takes into account these measured values while providing the statistical values.

The present invention relates to a process for the automatic control of the thickness of the extruded film.

Processes of such type are used both in flat sheet film extrusion as well as in blown film extrusion.

In modern extrusion plants these processes usually comprise the following process steps that are also specified in the preamble of the main claim 1:
Measurement of the thickness profile of the film just extruded with the help of a thickness-measuring probe that is moved along the surface of the film substantially perpendicular (x) to the conveying direction (z) of the extruded film. The thickness-measuring probe records for each measuring cycle (MZ) a thickness profile (P) of the film at least across parts of the expansion of the film perpendicular (x) to its conveying direction (z),
Transmitting the measured values to a control unit,
Storage of the measured values underlying the thickness profiles in a storage unit,
Provision of statistical values of the film thickness using a computer, where the computer takes into account measured values or information derived therefrom using a definite number of measuring cycles (MZ),
Determination of the deviations in the statistical values of the film thickness from a target value,
Generating control commands to a device for controlling the film thickness.

The measuring devices outlined above are known from published prior art. Thus the patent application DE 40 09 982 A1 proposes a capacitive sensor for measuring the thickness of the wall of a film tube. However, even other principles of measurement are used to measure the film thickness. For instance, even the measurements of the transmission behavior of beta radiation, gamma radiation, x-radiation and infrared radiation have also proved to be useful. In blown film plants they are usually guided around the film tube that is just extruded. In flat film plants the sensor traverses across the width of the flat film extruded.

In this connection, statistical statements about the development of the film thickness in terms of time generated using a computer serve to avoid an overmodulation or overshooting of the control process. For this purpose the computer takes into account measured values of a definite number of measuring cycles. The statistical values usually involve the computation of an average value or meridian. However, it is also possible to determine other statistical parameters.

Furthermore, it is possible to provide the computer with information derived from the measured values instead of the measured values themselves. This information derived from the measured values can be statistical values that result in the updated statistical values by taking into account the most recent measured values. Thus for instance, an average value can be computed by feeding the average value of the last N measurements to the computer. The computer then only has to take into account the current measured value while computing the updated average value.

Information derived from measured values can also exist in the form of recorded “older” control commands that are adjusted on the basis of current measured values.

The information derived by the computer from the measured values and/or the statistical values is fed to a control unit that controls a device for controlling the film thickness. The thickness of the film can be controlled using different means. Thus, for instance, the width of the die gap or of the die ring can be varied in certain sections in order to be able to increase or decrease the throughflow of the melt at the desired places.

However, the control unit can also control the temperature of the melt by means of heating or cooling agents. Using the temperature it is possible to control in a targeted manner the viscosity of the melt. Should the viscosity of a melt be higher in one place than the other places, then the melted mass can melt more strongly in this place, thus causing the film to have a lesser thickness in this place.

Likewise the thickness of the film can be changed by stretching it in places. In this context, the property of the film that allows the already solidified and partially cooled film to stretch is exploited. The regions of the film that are stretched more strongly subsequently exhibit a lesser thickness than the regions of the film that are stretched using lesser strength. The force required for stretching the film is frequently made available by blow air. In this case the control unit controls the volume flow of the blow air in certain regions.

The measurement processes described above have proved to be useful in practice particularly in continuous operation. However, since in recent times a trend toward job orders of smaller sizes and thus toward a more frequent change-over of the film material can be noted, increasingly greater significance is attached to the automatic control of the film thickness at the start of the extrusion process.

However, film materials with unacceptable thickness tolerances and thus rejections have been produced using automatic control processes according to prior art during an important time-span at the start of the extrusion process.

Therefore the objective of the present invention is to lower more quickly the deviations in the thickness of the film after the start of the extrusion process.

This objective is achieved by the fact that
The computer processes, during a predetermined time-frame at the start of the extrusion process, information derived from measured values using or for a greater number of measuring cycles than those recorded by the thickness-measuring probe in a time-frame of similar length during the normal operation and that
The computer takes into account these measured values while providing the statistical values.

The present invention takes advantage of the fact that the value of the statistical specifications increases with the number of the measuring cycles underlying the said statistical specifications.

It is advantageous if during a predetermined time-frame at the start of the extrusion process the thickness-measuring probe is moved faster along the extruded film than in the normal operation. This measure makes it possible to determine for each time-unit measured values using a larger number of measuring cycles than the measuring cycles used in the normal operation and to make these accessible to the computer.

However, even measured values or information derived therefrom can be used from measuring cycles that were recorded in other extrusion processes. In this case, a storage unit makes the measured values or the information derived therefrom accessible to the computer. Such measured values or information derived therefrom can be recorded and stored, for instance, during previous manufacturing processes of films of similar thickness on the same extrusion device. Thus the measured values are not deleted in each case after the completion of the manufacturing process of the film.

In this connection it is particularly advantageous if the storage unit provides the computer with only such measured values or information derived therefrom, which were recorded when the deviations in the film thickness from the target value lay within acceptable tolerances. In this manner the control unit can control the device for controlling the film thickness even at the start of the extrusion process in such a way that the thickness profile of the film exhibits the ideal path in the fastest way possible.

Furthermore, it is advantageous to assign various weighting factors to the measured values or to the information derived therefrom using different measuring cycles. These weighting factors define how strongly the individual measured values or the information derived therefrom contribute to the statistical values. In this manner it is possible to take into account different manufacturing parameters that influence the thickness of the film though they cannot be controlled directly.

It is particularly advantageous to change the weighting factors at the start of the extrusion process.

The object of the patent application is also a device that is suitable for executing the process according to the invention.

A preferred embodiment of this device has a storage unit in which measured values or information derived therefrom used in other extrusion processes are stored.

It is advantageous if the measured values or the information derived therefrom used in other extrusion processes stored in the storage device are assigned to the process parameters that prevailed when they were recorded.

These process parameters can include the following values among others:
Composition of the film layers
Thickness of the film layers
Sequence of the film layers
Ambient temperature and air moisture

A preferred embodiment of the present invention is set forth in the following objective description and the accompanying drawing of which the individual figures illustrate:

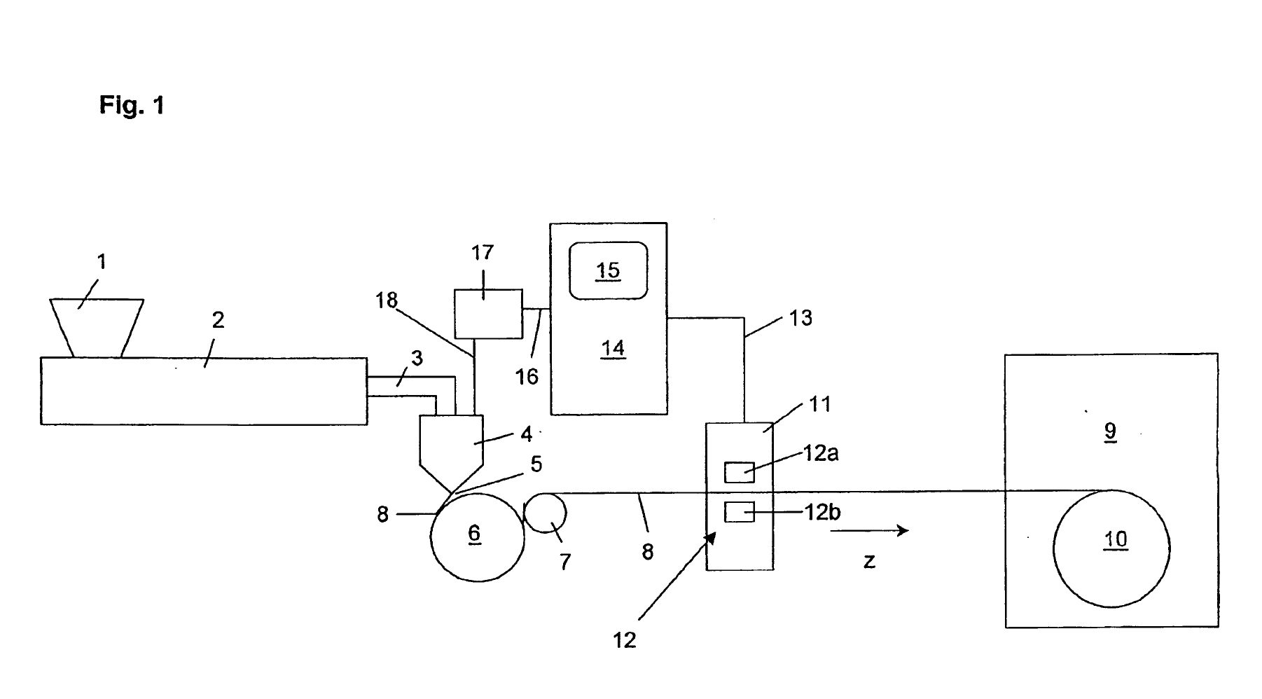

FIG. 1 side view of a device according to the invention for manufacturing a film using the process pursuant to the invention.

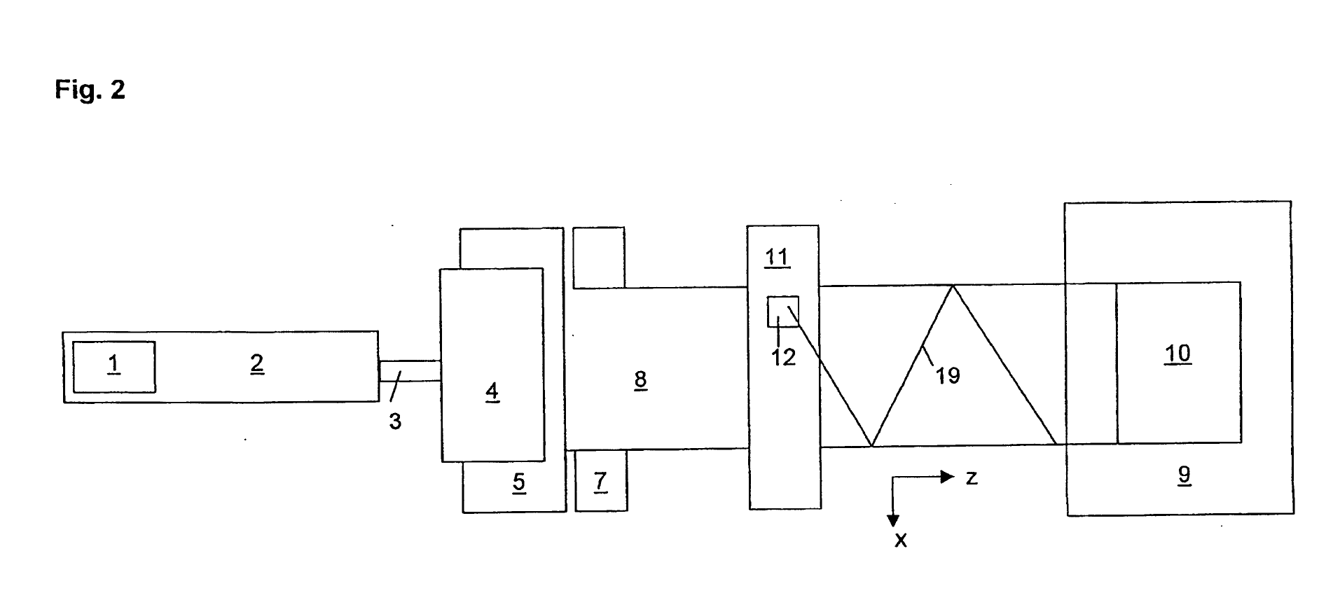

FIG. 2 top view of the device illustrated in FIG. 1

FIGS. 1 and 2 illustrate a device for manufacturing extruded films. A granulate is used as the starting material for manufacturing the films. The granulate is fed to the device by means of the feed hopper 1. From there the granulate enters into the extruder 2 in which it is molten by applying high pressure. This melt is fed to the sheet die 4 using the pipeline 3. The melt is substantially distributed inside the sheet die 4 on its entire width. The melt emerges from the die gap 5 and arrives onto the chill roller 6. The gap width of the die gap 5 can be changed in certain sections in a manner that is not illustrated here. The melt solidifies on the chill roller and becomes film 8. This film 8 wraps around the chill roller 6 to a large extent and is cooled down strongly by the latter. The film 8 is fed by means of a deflecting roller 7 to a winding device 9 where it is wound up into a roll 10.

A thickness-measuring device 11 measures the thickness of the film 8 after it has passed the deflecting roller 7. The thickness-measuring device 11 comprises the thickness-measuring probe 12 that consists of a transmitter 12a and a receiver 12b. The measured values are fed by means of a data line 13 to the computer and storage unit 14. The machine operator can access the measured values or the information derived therefrom by means of the monitor 15. The monitor 15 can be used for the input of parameters. If necessary, another input device that is not illustrated here can also be used for this purpose. The computer and storage unit 14 provides information to the control unit 17 by means of the data line 16 for controlling the device that controls the thickness of the film. From this information the control unit 17 determines control commands and transmits these using the control line 18 to the device that controls the thickness of the film. In the embodiment of the present invention illustrated here the control commands are used for a variation in the gap width of the die gap 5.

FIG. 2 illustrates the effective progression of the path 19 created by the measuring heads 12 if they move at a uniform speed in the direction (x) perpendicular to the conveying direction (z) of the film 8. For the purpose of determining a complete thickness profile of the film 8, the measuring heads 12 move up to the borders of the film 8.

List of Reference Symbols

| | |
|---|---|
| 1 | Feed hopper |
| 2 | Extruder |
| 3 | Pipeline |
| 4 | Sheet die |
| 5 | Die gap |
| 6 | Chill roller |
| 7 | Deflecting roller |
| 8 | Film |
| 9 | Winding device |
| 10 | Roll |
| 11 | Thickness-measuring device |
| 12 | Thickness-measuring probe |
| 13 | Data line |
| 14 | Computer and storage unit |
| 15 | Monitor |
| 16 | Data line |
| 17 | Control unit |
| 18 | Control line |
| 19 | Effective path progression |
| 12a | Transmitter of the thickness-measuring probe |
| 12b | Receiver of the thickness-measuring probe |
| x | Direction of movement of the measuring head 11 |
| z | Conveying direction |

1. Process for the automatic control of the thickness of extruded films that comprises the following features:
Measurement of the thickness profile of the film just extruded (8) with the help of a thickness-measuring probe (12) that is moved along the surface of the film substantially perpendicular (x) to the conveying direction (z) of the extruded film (8). The thickness-measuring probe records for each measuring cycle (MZ) a thickness profile (P) of the film (8) at least across parts of the expansion of the film (8) perpendicular (x) to its conveying direction (z),
Transmitting the measured values to a control unit (14, 15, 17),
Storage of the measured values underlying the thickness profiles in a storage unit (14),
Provision of statistical values of the film thickness (5) using a computer (14), where the computer (14) takes into account measured values or information derived therefrom using a definite number of measuring cycles (MZ),
Determination of the deviations in the statistical values of the film thickness (5) from a target value,
Generating control commands to a device for controlling the film thickness (5) characterized in
that during a predetermined time-frame at the start of the extrusion process, measured values or information derived therefrom using or for a greater number of measuring cycles is made accessible to the computer (14) than those recorded by the thickness-measuring probe (12) in a time-frame of similar length during the normal operation and that
that the computer (14) takes into account these measured values while providing the statistical values,
wherein at least a part of these measured values originate from the storage unit (14),
that makes accessible measured values or information derived therefrom to the computer (14),
wherein these measured values or information derived therefrom originate from measuring cycles that were recorded in another extrusion process.

2. Process pursuant to claim 1 characterized in that
the thickness-measuring probe (12) is moved during a predetermined time-frame at the start of the extrusion process more quickly along the surface of the extruded film (8) than in the normal operation
and in doing so determines for each time unit the measured values from a larger number of measuring cycles than the number of measuring cycles used in the normal operation
and makes these accessible to the computer (14).

3. Process pursuant to claim 1 characterized in that the storage unit (14) makes measured values or information derived therefrom accessible to the computer (14), which were recorded when the deviations in the film thickness (5) from the target value lay within acceptable tolerances.

4. Process pursuant to claim 1 characterized in that various weighting factors are assigned to the measured values or the information derived therefrom using different measuring cycles with which the contribution of the measured values or of the information derived therefrom to the statistical values is defined.

5. Process pursuant to claim 4 characterized in that
these weighting factors are changed at the start of the extrusion process.

6. Process pursuant to claim 1 characterized in that
the measured values or the information derived therefrom using other extrusion processes stored in the storage device (14) are assigned to
the process parameters that prevailed when they were recorded.

7. Device for the automatic control of the thickness of the extruded film (8) having the following features:
a thickness-measuring probe (12) for measuring the thickness profile of the film just extruded (8) that is moved along the surface of the film (8) substantially perpendicular (x) to the conveying direction (z) of the extruded film (8). The thickness measuring probe (12) records for each measuring cycle (MZ) a thickness profile (P) of the film (8) at least across parts of the expansion of the film (8) perpendicular (x) to its conveying direction (z),
transmitting the measured values to a control unit (14, 15, 17),
a storage unit (14) for recording the measured values and the information derived therefrom,
a computer (14) for providing statistical values of the film thickness (5) taking into account measured values or information derived therefrom using a definite number of measuring cycles (MZ)
wherein even the deviations in the statistical values of the film thickness (5) from a target value can be determined using the computer (14),
a device (17) for generating control commands to a device for controlling the film thickness (5) characterized in
a computer (14) using which it is possible to take into account, during a predetermined time-frame at the start of the extrusion process, measured values or information derived therefrom using or for a greater number of measuring cycles than those recorded by the thickness-measuring probe in a time-frame of similar length during the normal operation,
a storage unit (14) in which it is possible to store measured values or information derived therefrom using measuring cycles that were recorded in another extrusion process
communication means between the storage unit (14) and the computer (14) that provides to the computer (14) during a predetermined time-frame at the start of the extrusion process at least a part (14) of the measured values or information derived therefrom which the computer (14) then takes into account for this time-frame.

8. Process pursuant to claim 2 characterized in that the storage unit (14) makes measured values or information derived therefrom accessible to the computer (14), which were recorded when the deviations in the film thickness (5) from the target value lay within acceptable tolerances.

9. Process pursuant to claim 2 characterized in that various weighting factors are assigned to the measured values or the information derived therefrom using different measuring cycles with which the contribution of the measured values or of the information derived therefrom to the statistical values is defined.

10. Process pursuant to claim 3 characterized in that various weighting factors are assigned to the measured values or the information derived therefrom using different measuring cycles with which the contribution of the measured values or of the information derived therefrom to the statistical values is defined.

11. Process pursuant to claim 2 characterized in that
the measured values or the information derived therefrom using other extrusion processes stored in the storage device (14) are assigned to the process parameters that prevailed when they were recorded.

12. Process pursuant to claim 3 characterized in that
the measured values or the information derived therefrom using other extrusion processes stored in the storage device (14) are assigned to the process parameters that prevailed when they were recorded.

13. Process pursuant to claim 4 characterized in that
the measured values or the information derived therefrom using other extrusion processes stored in the storage device (14) are assigned to the process parameters that prevailed when they were recorded.

14. Process pursuant to claim 5 characterized in that
the measured values or the information derived therefrom using other extrusion processes stored in the storage device (14) are assigned to the process parameters that prevailed when they were recorded.
